(19) United States
(12) Patent Application Publication
(10) Pub. No.: US 2012/0268400 A1
(43) Pub. Date: Oct. 25, 2012

(54) METHOD AND SYSTEM FOR REVISING USER INPUT POSITION

(75) Inventors: Sheng Hua Bao, Beijing (CN); Jian Chen, Beijing (CN); Lu Cheng En, Beijing (CN); Rui Ma, Beijing (CN); Zhong Su, Beijing (CN); Rui Wang, Beijing (CN)

(73) Assignee: International Business Machines Corporation, Armonk, NY (US)

(21) Appl. No.: 13/446,275

(22) Filed: Apr. 13, 2012

(30) Foreign Application Priority Data
Apr. 19, 2011 (CN) 201110097928.2

(51) Int. Cl. G06F 3/041

(52) U.S. Cl. 345/173

(57) ABSTRACT

A method and system for revising user input position. The method for revising user input position includes, detecting input position of a user, revising the input position of the user based on a predefined revising model, to obtain an accurate position, where, a wrong input position of the user is at least analyzed in advance to obtain the revising model and in response to obtaining the accurate position, triggering an application corresponding to the accurate position. With the technology for automatically revising the input position of the user on the touch screen provided by the invention, it is possible to help the user more conveniently locate the needed content, so as to save the time of the user and improve the user experience.

### CROSS-REFERENCE TO RELATED APPLICATION

This application claims priority under 35 U.S.C. §119 from Chinese Patent Application No. 201110097928.2 filed Apr. 19, 2011, the entire contents of which are incorporated herein by reference.

### BACKGROUND OF THE INVENTION

1. Field of the Invention

The present invention generally relates to information processing technical field, and more particularly, to a method and system for revising user input position.

2. Description of Related Art

With the development of the information technology, the forms of information terminals are numerous. For example, cell phone, navigator, hand computer, pad computer, kiosk, handheld game machine and the like have become popular. However, when a user uses these information apparatuses, there are some bad user experiences. For example, sometimes the user wants to click on an application, but since the position pressed by the finger or the position pressed by the inputter is shifted, undesired applications are clicked on. The time of the user is wasted and thus, creates a bad user experience. It normally needs the user to repeat or carefully click on the desired application, to make the user enters into the correct application. With the wide usage of touch screens, the inconvenient experience of the user becomes an important problem to solve.

The prior art attempts to improve such experience of the user. In U.S patent application publication No. US2010/0302212A1, the invention proposes obtaining and setting a series of finger characters from different users' fingers, and then performing characterized operations on the screen according to these characters, such as providing big icons for big fingers, and providing small icons for small fingers, and so on. However, the method needs the user and the software to make a relatively big change, and is not convenient when using it.

Thus, a method and system for revising user input position is needed.

### SUMMARY OF THE INVENTION

One aspect of the invention provides a method for revising user input position. The method includes detecting input position of a user, revising the input position of the user based on a predefined revising model, to obtain an accurate position, where, a wrong input position of the user is at least analyzed in advance to obtain the revising model, and in response to obtaining the accurate position, triggering an application corresponding to the accurate position.

Another aspect of the invention provides a system for revising user input position. The system includes a detecting unit, to detect input position of a user, a revising unit, to revise the input position of the user based on a predefined revising model, to obtain an accurate position, where, a wrong input position of the user is at least analyzed in advance by an analyzing unit to obtain the revising model, and a triggering unit, to, in response to obtaining the accurate position, trigger an application corresponding to the accurate position.

In yet another aspect of the invention provides a computer readable storage medium. The computer readable storage medium tangibly embodies a computer readable program code having computer readable instructions which, when implemented, cause a computer to carry out the steps of a method including detecting input position of a user, revising the input position of the user based on a predefined revising model, to obtain an accurate position, where, a wrong input position of the user is at least analyzed in advance to obtain the revising model, and in response to obtaining the accurate position, triggering an application corresponding to the accurate position.

With the technology for automatically revising the input position of the user on the touch screen provided by the invention, it is possible to help the user more conveniently locate the needed content, so as to save the time of the user and improve the user experience.

### BRIEF DESCRIPTION OF THE DRAWINGS

The features and advantages of the embodiments of the invention will be particularly explained with reference to the appended drawings. If possible, the same or like reference number denotes the same or like component in the drawings and the description. In the drawings:

FIG. 1 shows a first embodiment for revising user input position of the invention;

FIGS. 2 and 3 show embodiments for analyzing a wrong input position of the user to obtain a revising model;

FIG. 4 shows a embodiment for analyzing a correct input position of the user to obtain a revising model;

FIGS. 5 and 6 show distributions of positive and negative samples relative to buttons;

FIG. 7 shows a preferred embodiment for obtaining the revising model of the invention;

FIGS. 8 and 9 show a second embodiment for revising user input position of the invention; and

FIG. 10 shows a structural diagram of a system for revising user input position of the invention.

### DETAILED DESCRIPTION OF THE PREFERRED EMBODIMENTS

Below, the exemplary embodiments of the invention will be described in detail with reference to the drawings in which the embodiments of the invention are illustrated, and like reference number always indicates the same element. It should be understood that the invention is not limited to the disclosed exemplary embodiments. It should be also understood that not every feature of the method and apparatus is necessary for implementing the invention to be protected by any claim. In addition, in the whole disclosure, when displaying or describing the process or the method, the steps of the method can be executed in any order or simultaneously, unless it is clear from the context that one step depends on another previously-executed step. In addition, there can be prominent time interval between the steps.

Every user has a unique fixed usage habit. For example, some users have thick fingers, and in the case of small buttons, in order to clearly see the application corresponding to the accurate position, their input positions to be clicked on often shift down and make errors. This habit is difficult to correct in a short time period. Based on this finding, it is proposed a first embodiment for revising user input position of the invention.

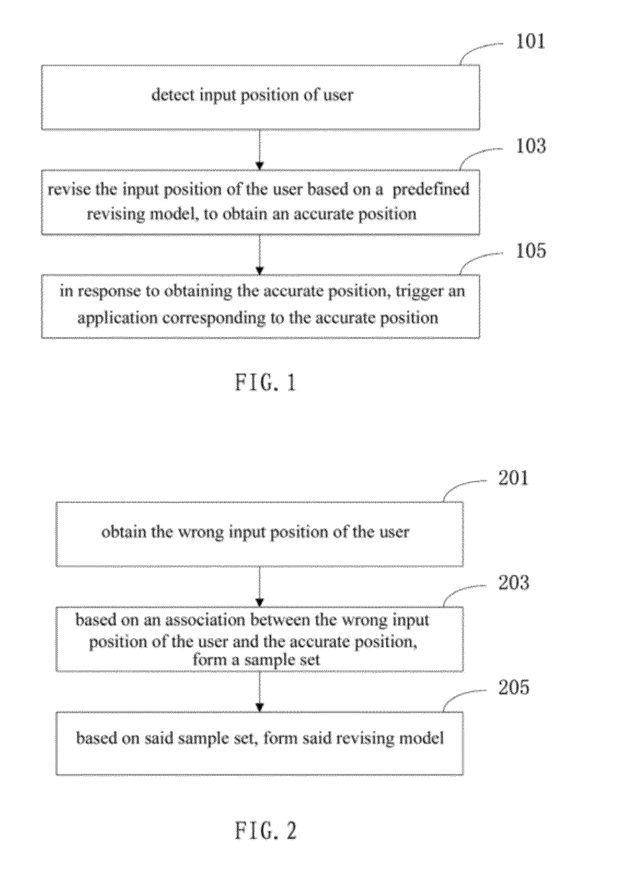

As shown in FIG. 1, in step 101, the input position of the user is detected. The input apparatus can be the information apparatus such as cell phone, navigator, hand computer, pad computer, kiosk, and handheld game machine and so on. Preferably, the input interface is a touch screen of the related apparatus. In these apparatuses, software or hardware for detecting the user's input position has already been installed, which will not be described again. In step 103, the input position of the user is revised based on a predefined revising model to obtain an accurate position, wherein, a wrong input position of the user is at least analyzed in advance to obtain said revising model. Said revising model is the one which undergoes a sample training in advance, and is stored in a related storage device to correct the input of the user.

This embodiment obtains shown revising model by at least analyzing the wrong input position of the user in advance, which will be descried in detail in the subsequent preferred embodiments. Due to relative fixed feature of the user's usage habit, such revising model is relatively effective. In step 105, in response to obtaining the accurate position, an application corresponding to the accurate position is triggered. The adjusted accurate position is used as the input of the user to trigger the application which is desired by the user to launch. The bad user experience due to wrongly clicking can be avoided. The original clicking habit of the user is remained in order to make the user's input natural and smooth.

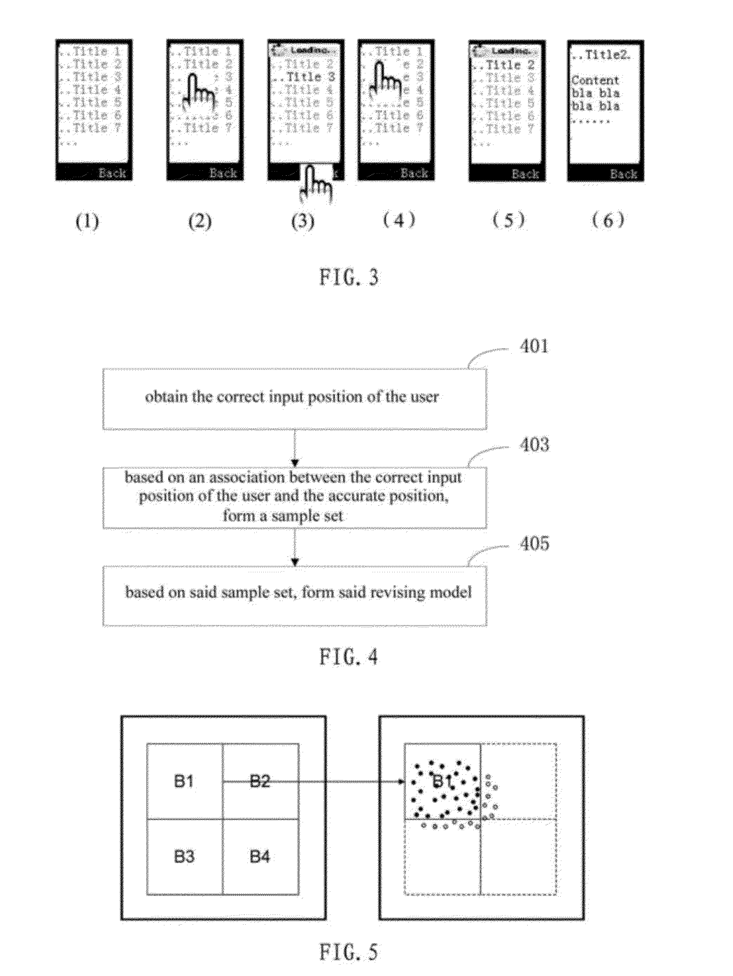

FIGS. 2 and 3 show embodiments for analyzing a wrong input position of the user to obtain a revising model. In step 201, a wrong input position of the user is obtained. In step 203, a sample set is formed based on an association between the wrong input position of the user and the accurate position. In step 205, based on the sample set, the revising model is formed. As shown in FIG. 3, wrong input of the user will follow a certain pattern. The sub-diagram (1) of FIG. 3 shows a common webpage link list, i.e., (application) Title 1 to Title 7. The sub-diagram (2) shows a touch behavior of the user, with the touching area between Title 2 and Title 3. The sub-diagram (3) shows a back behavior of the user, that is, after the user finds the response by the system is Title 3, he re-clicks Back button. The sub-diagram (4) shows a retouch behavior of the user, that is, after the user learns the lesson of the last touch, the touch of the user is closer to Title 2. The sub-diagram (5) shows a loading process of the Title 2, and the sub-diagram (6) shows a particular content viewing behavior of the Title 2.

Thus, it can be seen that the wrong click of the user follows the pattern of: wrong input position->undesired application->back->accurate position->desired application, in which the accurate position refers to a response area corresponding to the application which is truly desired by the user to use. Such pattern can be used to determine the actions of the wrong input position of the user: obtaining an input position of the user; and in response to obtaining a back action and an action for re-determining the accurate position of the user, determining the input position of the user as a wrong input position. The method for detecting the wrong input position of the user can be realized to monitor the input position path of the user in real time, and can be preferably realized to store the input position path of the user as a log which can be analyzed offline after a certain data is accumulated.

In order to assure more accurate and complete revising model, FIG. 4 shows a embodiment for analyzing a correct input position of the user to obtain a revising model. In step 401, a correct input position of the user is obtained. The correct input position should be understood as the input position of the user falling on the accurate position with the user using the related application according to normal operations, according to the above pattern.

In step 403, based on an association between the correct input position of the user and the accurate position, a sample set is formed. Such sample set can include samples related to wrong input positions of the embodiment as shown in FIG. 3 (which can be called as negative samples) and samples related to correct input positions (which can be called as positive samples); and in step 405, based on the sample set, the revising model is formed.

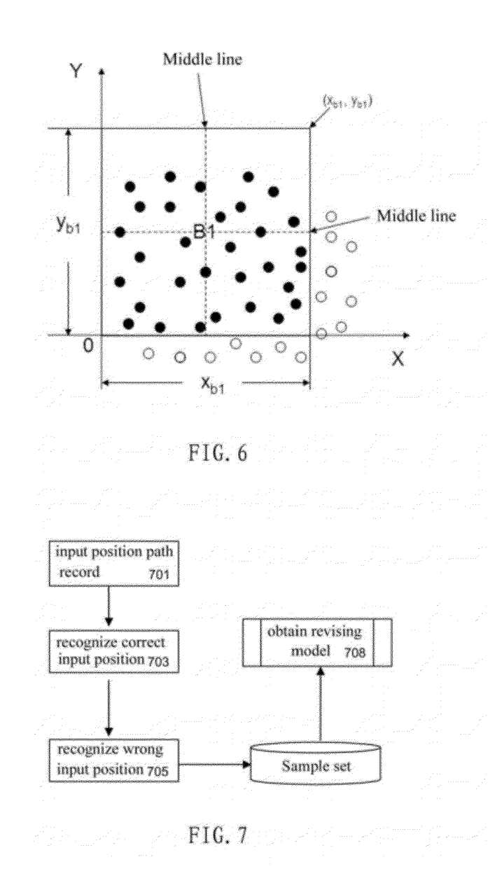

Below, the method for how the revising model is obtained based on the sample set will be described in detail in combination with FIGS. 5 and 6. For every button which meets a condition (available triggering area), such as B1, B2, B3 and B4 in FIG. 5, some positive samples and negative samples are obtained to learn. Here, taking the button B1 as an example, the example of the positive samples is that the user desires to click on B1, and in fact the user clicks on B1, such as solid points within the area of the accurate position of B1 in FIGS. 5 and 6.

The example of the negative samples is that the user desires to click on B1, but in fact the user does not click on B1, but on adjacent area around B1, such as hollow points in FIGS. 5 and 6. It is to be noted that the negative samples can be used only to obtain the revising model, to realize the corresponding technical effect. A rectangular coordinate as shown in FIG. 6 can be built for the button B1, and assuming that the set of all the sample points related to the button B1 is A, the screen coordinate area covered by the button B1 is R, and the coordinate of a certain sample point p is shown as (xₚ,yₚ), the positive sample coordinates and the negative sample coordinates are defined as follows:

the positive sample coordinates: P={(xₚ, yₚ)|p∈A∩(xₚ, yₚ)∈R}

the negative sample coordinates: N={(xₚ,yₚ)|p∈A∩(xₚ,yₚ)∉R}

The learning process of the revising model is divided into two steps of:

Step 1: Bias Learning of a Single Button

The learning of this step can be realized by many existing methods, and two particular learning methods are exemplified as follows:

1. Mathematical Expectation

For the B1 button as shown in FIGS. 5 and 6, the simplest mathematical expectation can be used to learn, with the process as follows:

Input: A=P∪N , i.e., the coordinates of all the positive and negative samples; the coordinate of the centroid point of the button B1 is

$$Δ x = \frac{1}{\vert A \vert} {\sum }_{p ∈ A} ( \begin{matrix}{x}_{p} & {x}_{c}\end{matrix} )$$

$$Δ y = \frac{1}{\vert A \vert} {\sum }_{p ∈ A} ( \begin{matrix}{y}_{p} & {y}_{c}\end{matrix} )$$

x_{b1} and y_{b1} are length and width of the button B1 respectively.

Output: Δx & Δy.

The calculation formula is:

$$( {x}_{c} , {y}_{c} ) = ( \frac{1}{2} {x}_{b 1} , \frac{1}{2} {y}_{b 1} ) ,$$

|A| indicates the number of the sets in the set A. Δx indicates the x coordinate shift of the sequential user input positions to be rectified for the button B1. Δy indicates the y coordinate shift of the sequential user input positions to be rectified for the button B1.

2. Mean Value Function

For the B1 button as shown in FIGS. 5 and 6, in the case of unchanged input and output, the simple mean value function can be used to learn, with the process as follows:

Input: A=P∪N , i.e., the coordinates of all the positive and negative samples; the coordinate of the centroid point of the button B1 is

$$( {x}_{c} , {y}_{c} ) = ( \frac{1}{2} {x}_{b 1} , \frac{1}{2} {y}_{b 1} ) ,$$

x_{b1} and y_{b1} are length and width of the button B1 respectively.

Output: Δx & Δy.

The calculation formula is:

Δx=med{xₚ−x_{c}|p∈A}

Δy=med{yₚ−y_{c}|p∈A}

med indicates taking the mean value of the set.

Step 2: Average Bias Learning of all the Buttons

Within one screen, there are several available triggering area for several buttons, each available triggering are corresponding to a group of Δx&Δy. The adjustment for the whole screen can take the mean value as follows:

$$Δ X = \frac{1}{num ( buttons )} \sum ( Δ x )$$

$$Δ Y = \frac{1}{num ( buttons )} \sum ( Δ y )$$

ΔX indicates the x coordinate adjustment of the sequential user input positions within the scope of the whole screen. ΔY indicates the y coordinate adjustment of the sequential user input positions within the scope of the whole screen. Num (buttons) indicates the number of the buttons which undergo the sample learning in the whole screen. Thus, the samples of a limited number of buttons in the whole screen can be learned, to apply for the whole input screen, thereby improving the efficiency of learning. The revising model can be obtained based on the above obtained adjustment values: (x, y)=(x+ΔX, y+ΔY), that is, for a sequential user input position (x, y), it can be revised as its accurate position (x+ΔX, y+ΔY) by the revising model.

It is to be noted, the person skilled in the art can easily obtain said revising model based on the application and according to other suitable learning model. In addition, the above rectangle “button” from is only exemplary, and the “button” can also be in a form of a line of words or other patterns and so on.

FIG. 7 shows another preferred embodiment for obtaining the revising model of the invention. In step 701, an input position path record is received. The input position path record records the input history of the user in a form of log, such as correct inputs and wrong inputs. The input history of one day, one week and even longer can be record as the input position path record. It can be the input position of the user and the time sequence for the function/application. For example, one record is <time n, input position, corresponding function n or application n>, wherein, n is a sequential number.

In steps 703 and 705, correct position inputs and wrong position inputs are recognized. Since the determined corresponding function or application has determined accurate position, it only needs to compare the input position with the accurate position to obtain whether the input position of the user is correct or wrong. The respective input positions as samples form a sample set. In step 708, the revising model is obtained based on said sample set.

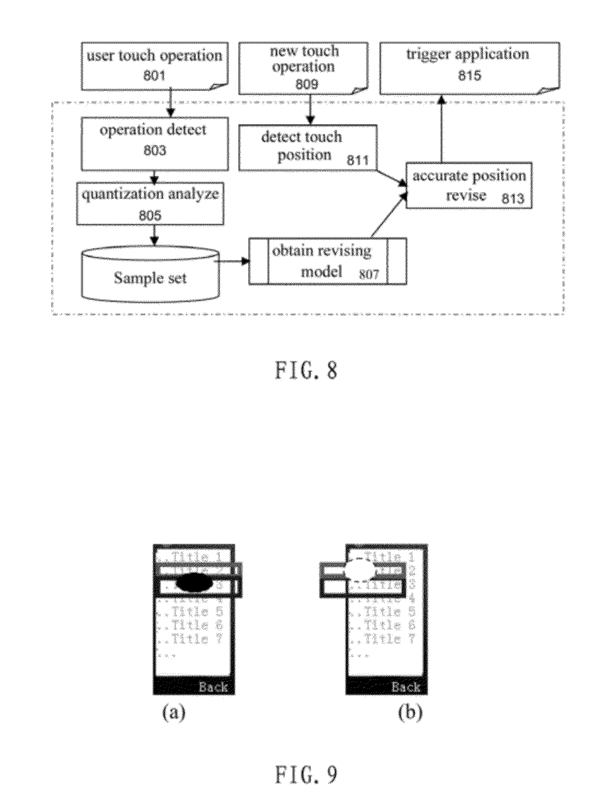

FIGS. 8 and 9 show a third embodiment for revising user input position of the invention. The embodiment is based on the input manner of a screen of an information apparatus. The embodiment is divided into two stages. One stage is the stage for pre-generating revising model, in which in step 801, the user performs a touch operation by the touch screen, to use various (program) application. In step 803, the operation of the user is detected, for example in real time or in a form of log, to record the input position path of the user.

In step 805, the input position path of the user is quantization-analyzed, to obtain a sample set including positive samples and negative samples. In step 807, a revising model is obtained based on the sample set. The revising model as shown in FIG. 8 is obtained in advance, and preferably, the revising model can be updated in real time or regularly according to the addition of new samples (new inputs of the user), to adapt to the change of the user's habit.

The second stage is the stage for revising the input position of the user. In step S809, the user performs a new touch operation, in step 811, the new touch position of the user is detected, in step 803, the detected touch position is revised as an accurate position according to the obtained revising model, and based on the determined accurate position, in step 815, the information apparatus triggers the corresponding application according to the accurate position to respond to the new touch operation of the user. As shown in FIG. 9, the actual touch area of the user is sensed by the information apparatus as Title 3, and the adjusted touch target is Title 2.

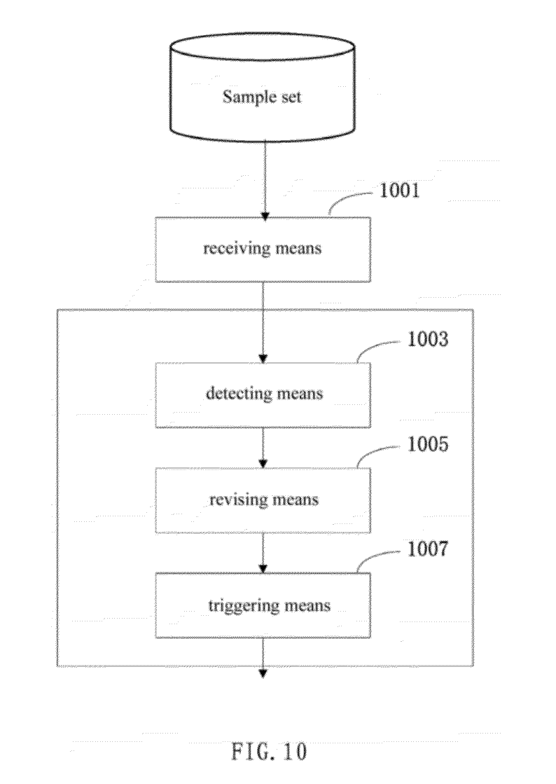

Another aspect of the invention provides a system for revising user input position as shown in FIG. 10. The system includes: a detecting means 1003, configured to detect input position of a user; a revising means 1005, configured to revise the input position of the user based on a predefined revising model, to obtain an accurate position, wherein, a wrong input position of the user is at least analyzed in advance by an analyzing means 1001 to obtain said revising model; and a triggering means 1007, be configured to, in response to obtaining the accurate position, trigger an application corresponding to the accurate position.

Preferably, said analyzing means 1001 is further configured to obtain the revising model by analyzing a correct input position of the user in advance.

Preferably, said analyzing means 1001 includes: a wrong position obtaining means, configured to obtain the wrong input position of the user; a sample set forming means, configured to, based on an association between the wrong input position of the user and the accurate position, form a sample set; and a revising model forming means, configured to, based on said sample set, form said revising model.

Preferably, wrong position obtaining means includes: an user input position obtaining means, configured to obtain an input position of the user; and a wrong input position determining means, configured to, in response to obtaining a back action and an action for re-determining the accurate position of the user, determine the input position of the user as a wrong input position.

Preferably, the analyzing means 1005 further includes: a user correct input position obtaining means, configured to obtain the correct input position of the user; a sample set forming means, configured to, based on an association between the correct input position of the user and the accurate position, form a sample set; and a revising model forming means, configured to, based on said sample set, form said revising model.

Preferably, the revising model is formed based on the sample set, and according to one of the Mathematical Expectation Model and the Mean Value Model.

Preferably, the system further includes: a recorder, for recording an input path of the user.

Preferably, the system has a touch screen.

Although the exemplary embodiments of the invention are described here with reference to the drawings, it should be understood that the invention is not limited to these precise embodiments, and the person skilled in the art can make various modifications to the embodiments without departing from the scope and the principle of the invention. All these variations and modifications are intended to be contained in the scope of the invention defined by the appended claims.

According to the above description, the person skilled in the art will know that the invention can be embodied as a system, a method or a computer program product. Thus, the invention can be implemented in particular in following forms, i.e., a whole hardware, a whole software (including firmwares, residing softwares, microcodes), or a combination of the software parts normally called “circuit”, “module” or “system” in the text and the hardware parts. In addition, the invention can also adopt the form of computer program product in any medium of expression, with computer-usable program codes included in the medium.

Any combination of one or more computer-usable or computer-readable mediums can be used. The computer-usable or computer-readable mediums can be, but not limited to for example, electric, magnetic, optic, electro-magnetic, infrared, or semiconductor system, apparatus, device or transmission medium. More particular examples of the computer-readable mediums include: electric connection with one or more wires, portable computer disk, hard disk, Random Access Memory (RAM), Read Only Memory (ROM), Erasable Programmable Read Only Memory (EPROM or flash memory), optical fiber, portable Compact Disk Read Only Memory (CD-ROM), optical storage device, such as transmission medium supporting Internet or Intranet, or magnetic storage device.

It is appreciated that, the computer-usable or computer-readable mediums can be even papers or other suitable mediums with programs printed thereon, because such paper or other mediums can be for example, electrically scanned to electrically obtain the program, and then compiled, interpreted or processed in a suitable manner, and stored in a computer memory as necessary. In the context of this document, the computer-usable or computer-readable medium can be any medium for containing, storing, transferring, transporting, or transmitting programs to be used by instruction execution system, apparatus or device, or to be associated with the instruction execution system, apparatus or device. The computer-usable medium can include data signal embodying the computer-usable program codes, transmitted in the base band or as a part of the carrier. The computer-usable program codes can be transmitted by any suitable medium, including, but not limited to, wireless, wired, cable, RF and so on.

The computer program codes for performing the operations of the invention can be composed in any combination of one or more programming languages including Object-Oriented programming languages, such as Java, Smalltalk, C++ and so on, and normal process programming languages, such as “C” programming language or like programming languages. The program codes can be executed entirely on the user's computer, partially on the user's computer, as one independent software package, partially on the user's computer and partially on a remote computer, or entirely on the remote computer or a Web server. In the latter case, the remote computer can be connected to the user's computer by any type of network, including Local Area Network (LAN) or Wide Area Network (WAN), or to external computers (by for example the Internet web service provider using Internet).

In addition, each block of the flowchart and/or block diagram, and the combinations of blocks in the flowchart and/or block diagram of the invention can be realized by computer program instructions, which can be provided to processors of general computers, dedicated computers or other programmable data processing apparatus to produce one machine to enable generating the means for the functions/operations prescribed in blocks in the flowchart and/or block diagram by these instructions executed by the computers or other programmable data processing apparatus.

These computer program instructions can also be stored in computer-readable mediums capable of instructing computers or other programmable data processing apparatus to operate in a particular manner. Thus, the instructions stored in the computer-readable medium generate a manufacture of instruction means for realizing the functions/operations prescribed in blocks in the flowchart and/or block diagram.

The computer program instructions can also be loaded into a computer or other programmable data processing apparatus, to enable the computer or other programmable data processing apparatus to execute a series of operation steps, to generate the process realized by the computer, thereby providing a process of realizing the functions/operations prescribed in blocks in the flowchart and/or block diagram in the instructions executed on the computer or other programmable apparatus.

The flowcharts and the block diagrams in the drawings illustrate the possible architecture, the functions and the operations of the system, the method and the computer program product according the embodiments of the invention. In this regard, each block in the flowcharts or block diagrams can represent a portion of a module, a program segment or a code, and said portion of the module, the program segment or the code includes one or more executable instructions for implementing the defined logical functions.

It should be also noted that in some implementations as alternatives, the functions labeled in the blocks can occur in an order different from the order labeled in the drawings. For example, two sequentially shown blocks can be substantially executed in parallel in fact, and they sometimes can also be executed in a reverse order, which is defined by the referred functions. It also should be also noted that, each block in the flowcharts and/or the block diagrams and the combination of the blocks in the flowcharts and/or the block diagrams can be implemented by a dedicated system based on hardware for executing the defined functions or operations, or can be implemented by a combination of the dedicated hardware and computer instructions.

1. A method for revising user input position, the method comprising the steps of:
detecting input position of a user;
revising the input position of the user based on a predefined revising model, to obtain an accurate position, wherein, a wrong input position of the user is at least analyzed in advance to obtain said revising model; and
in response to obtaining the accurate position, triggering an application corresponding to the accurate position.

2. The method according to claim 1, further comprising the step of:
obtaining said revising model by analyzing a correct input position of the user in advance.

3. The method according to claim 1, wherein, said at least analyzing wrong input positions of the user in advance to obtain said revising model includes:
obtaining the wrong input position of the user;
based on an association between the wrong input position of the user and the accurate position, forming a sample set; and
based on said sample set, forming said revising model.

4. The method according to claim 3, wherein said obtaining the wrong input position of the user includes:
obtaining an input position of the user; and
in response to obtaining a back action and an action for redetermining the accurate position of the user, determining the input position of the user as a wrong input position.

5. The method according to claim 2, wherein, said obtaining said revising model by analyzing a correct input position of the user in advance includes:
obtaining the correct input position of the user;
based on an association between the correct input position of the user and the accurate position, forming a sample set; and
based on said sample set, forming said revising model.

6. The method according to claim 3, wherein, said revising model is formed based on the sample set, and according to one of the Mathematical Expectation Model and the Mean Value Model.

7. The method according to claim 3, further comprising the step of:
recording an input path of the user.

8. The method according to claim 1, wherein, said input position is the input position of the user on a touch screen.

9. A system for revising user input position, comprising:
a detecting unit, configured to detect input position of a user;
a revising unit, configured to revise the input position of the user based on a predefined revising model, to obtain an accurate position, wherein, a wrong input position of the user is at least analyzed in advance by an analyzing unit to obtain said revising model; and
a triggering unit, be configured to, in response to obtaining the accurate position, trigger an application corresponding to the accurate position.

10. The system according to claim 9, wherein, said analyzing unit is further configured to obtain said revising model by analyzing a correct input position of the user in advance.

11. The system according to claim 9, wherein, said analyzing unit includes:
a wrong position obtaining unit, configured to obtain the wrong input position of the user;
a sample set forming unit, configured to, based on an association between the wrong input position of the user and the accurate position, form a sample set; and
a revising model forming unit, configured to, based on said sample set, form said revising model.

12. The system according to claim 10, wherein said wrong position obtaining unit includes:
an user input position obtaining unit, configured to obtain an input position of the user; and
a wrong input position determining unit, configured to, in response to obtaining a back action and an action for redetermining the accurate position of the user, determine the input position of the user as a wrong input position.

13. The system according to claim 9, wherein, said analyzing unit further includes:
a user correct input position obtaining unit, configured to obtain the correct input position of the user;
a sample set forming unit, configured to, based on an association between the correct input position of the user and the accurate position, form a sample set; and
a revising model forming unit, configured to, based on said sample set, form said revising model.

14. The system according to claim 10, wherein, said revising model is formed based on the sample set, and according to one of the Mathematical Expectation Model and the Mean Value Model.

15. The system according to claim 10, further comprising:
a unit for recording an input path of the user.

16. The system according to claim 9, wherein, said system has a touch screen, and said input position is the input position of the user on the touch screen.

17. A non-transitory computer readable storage medium tangibly embodying a computer readable program code having computer readable instructions which, when implemented, cause a computer to carry out the steps of a method comprising:
detecting input position of a user;
revising the input position of the user based on a predefined revising model, to obtain an accurate position, wherein, a wrong input position of the user is at least analyzed in advance to obtain said revising model; and
in response to obtaining the accurate position, triggering an application corresponding to the accurate position.
